(19) United States
(12) Patent Application Publication
(10) Pub. No.: US 2018/0245173 A1
(43) Pub. Date: Aug. 30, 2018

(54) Method for Contactlessly Cooling Steel Sheets and Device Therefor

(71) Applicants: VOESTALPINE Stahl GmbH, Linz (AT); VOESTALPINE Metal Forming GmbH, Krems an der Donau (AT)

(72) Inventors: Markus Brummayer, Aschach (AT); Kurt Etzelsdorfer, Leonding (AT); Reiner Kelsch, Mutlangen (DE); Andreas Sommer, Abtsgm?nd (DE); Benedikt Tutewohl, Durlangen (DE)

(21) Appl. No.: 15/577,271

(22) PCT Filed: May 18, 2016
(86) PCT No.: PCT/EP2016/061101

§ 371 Date: Nov. 27, 2017

(30) Foreign Application Priority Data
May 29, 2015 (DE) 102015108514.3
Aug. 7, 2015 (DE) 102015113056.4

(51) Int. Cl. C21D 9/46; C21D 6/00; C21D 1/673; C21D 1/613; C21D 9/00; C23C 2/28; C22C 38/28; C22C 38/06; C22C 38/04; C22C 38/02; C22C 38/00; C22C 38/32; F27D 7/02

(52) U.S. Cl. CPC C21D 9/46; C23C 2/06; C21D 6/002; C21D 6/008; C21D 1/673; C21D 1/613; C21D 9/0062; C23C 2/28; C22C 38/28; C22C 38/06; C22C 38/04; C22C 38/02; C22C 38/002; C22C 38/001; C22C 38/32; F27D 7/02; C21D 2211/001; C21D 2211/008; C21D 6/005

(57) ABSTRACT

A method for producing a hardened steel component in which a sheet blank is stamped out and the stamped sheet blank is heated to a temperature ≥Ac₃ and as needed, is kept at this temperature for a predetermined time in order to carry out the austenite formation and then the sheet blank, which has been heated all over or only in some regions, is transferred to a forming die, is formed in the forming die, and in the forming die, is cooled at a speed that lies above the critical hardening speed and is thus hardened or else the sheet blank is completely cold formed and the formed sheet blank is heated all over or only in some regions to a temperature >Ac₃ and as needed, is kept at this temperature for a predetermined time in order to carry out the austenite formation and then the sheet blank, which has been heated and formed all over or only in some regions, is transferred to a hardening die, and is hardened in the hardening die at a speed that lies above the critical hardening speed; the steel material is adjusted in a transformation-delaying way so that at a forming temperature that lies in the range from 450° C. to 700° C., a quench hardening takes place through the transformation of the austenite into martensite; after the heating and before the forming, an active cooling takes place in which the sheet blank or parts of the sheet blank is/are cooled at a cooling speed of >15 K/s; for the homogeneous, contactless cooling of hot sheet blanks or components, a cooling apparatus and an article with a hot surface are moved relative to each other; the cooling apparatus has at least two cooling blades or cooling columns that are parallel to and spaced apart from each other; oriented toward the sheet blank to be cooled or the component to be cooled, the cooling blades or cooling columns have a nozzle edge with nozzles; the nozzles direct a cooling fluid at the surface of the sheet blank or the component and after the cooling fluid contacts the hot surface, it flows away in the space between the blades or cooling columns.

The invention relates to a method for contactless cooling of steel sheets and to an apparatus therefor.

In the technical field, cooling processes are needed in many areas, for example when it is necessary to cool flat plates, but also when it is necessary to cool glass surfaces, for example in glass production, or to cool processor units and the like.

Prior cooling systems are either very expensive or are kept quite simple, e.g. by blowing air or other fluids such as water or oil; this entails the disadvantage that unfavorable, uncontrolled flow conditions always occur on the surface, which then become a problem when a particularly defined cooling is required.

In the prior art, it must be largely assumed that disadvantageous flow conditions, so-called cross flow, exist on the flat surface that is to be cooled and this causes heterogeneous surface temperatures. This is particularly disadvantageous if homogeneous temperatures are required in the region of the surface in order to achieve homogeneous material properties. In particular, non-homogeneous surface temperatures also cause warpage.

Conventional cooling methods do not permit a controlled achievement of a predetermined target temperature, nor do they make it possible to systematically set virtually any cooling rate up to a maximum achievable cooling rate.

There are particular difficulties if different material thicknesses or starting temperatures are present on a cooling surface, which are to be cooled to homogeneous temperature conditions.

It is known that so-called press-hardened components made of sheet steel are used particularly in automobiles. These press-hardened components made of sheet steel are high-strength components that are particularly used as safety components of the vehicle body region. In this connection, the use of these high-strength components makes it possible to reduce the material thickness relative to a normal-strength steel and thus to achieve low vehicle body weights.

With press-hardening, there are basically two different possibilities for manufacturing such components. A distinction is drawn between the so-called direct and indirect methods.

In the direct method, a steel sheet blank is heated to a temperature above the so-called austenitization temperature and if need be, is kept at this temperature until a desired degree of austenitization is achieved. Then this heated blank is transferred to a forming die and in this forming die, is formed into the finished component in a one-step forming procedure and in the process of this, is simultaneously cooled by the cooled forming die at a speed that lies above the critical hardening speed. This produces the hardened component.

In the indirect method, possibly in a multi-step forming process, the component is first formed almost completely. This formed component is then likewise heated to a temperature above austenitization temperature and if need be, is kept at this temperature for a desired, necessary amount of time.

Then this heated component is transferred to and inserted into a forming die that already has the dimensions of the component or the final dimensions of the component, possibly taking into account the thermal expansion of the preformed component. After the die—which is in particular cooled—is closed, the preformed component is thus only cooled in this die at a speed that lies above the critical hardening speed and is thus hardened.

In this connection, the direct method is somewhat easier to execute, but it only enables the production of shapes that can actually be produced in a single forming step, i.e. relatively simple profile shapes.

The indirect method is somewhat more complicated, but is also able to produce more complex shapes.

In addition to the need for press-hardened components, a need has also arisen to not produce such components out of uncoated steel sheet, but rather to provide such components with a corrosion protection layer.

In automotive engineering, the only options for the corrosion protection layer are aluminum or aluminum alloys, which are used much less often, or zinc-based coatings, for which there is much more demand. In this connection, zinc has the advantage that it not only provides a protective barrier layer like aluminum, but it also provides a cathodic corrosion protection. In addition, zinc-coated press-hardened components fit better into the overall corrosion protection of vehicle bodies since bodies are completely galvanized in current popular design. In this respect, it is possible to reduce or even eliminate the occurrence of contact corrosion.

Both methods, however, involve disadvantages that are also discussed in the prior art. With the direct method, i.e. hot forming of press-hardened steels with a zinc coating, micro-cracks (10 μm to 100 μm) or even macro-cracks occur in the material; the micro-cracks occur in the coating and the macro-cracks even extend through the entire cross-section of the sheet. Such components with macro-cracks are not suitable for further use.

In the indirect method, i.e. cold forming with a subsequent hardening and residual forming, micro-cracks also occur in the coating, which are likewise unwanted, but are far and away less pronounced.

Up to this point, except for components in the Asian market, zinc-coated steels have not come into wide use in the direct method, i.e. hot forming. In this case, steels with an aluminum/silicon coating are used.

An overview is given in the publication “Corrosion resistance of different metallic coatings on press hardened steels for automotive,” Arcelor Mittal Maiziere Automotive Product Research Center F-57283 Maiziere-Les-Mez. This publication states that for the hot forming process, there is an aluminized boron/manganese steel that is sold commercially under the name Usibor 1500P. In addition, for purposes of cathodic corrosion protection, zinc-precoated steels are sold for the hot forming method, namely galvanized Usibor GI with a zinc coating, which contains low percentages of aluminum, and a so-called galvannealed, coated Usibor GA, which has a zinc layer with 10% iron.

It should be noted that the zinc/iron phase diagram reveals that above 782° C., a large area is produced in which liquid zinc/iron phases occur as long as the iron content is low, in particular less than 60%. But this is also the temperature range in which the austenitized steel is hot formed. It should also be noted, however, that if the shaping takes place at a temperature above 782° C., there is a high risk of stress corrosion due to fluid zinc, which presumably penetrates into the grain boundaries of the base steel, causing macro-cracks in the base steel. Furthermore, with iron contents of less than 30% in the coating, the maximum temperature for shaping a safe product without macro-cracks is lower than 782° C. This is the reason why the direct shaping method is not used herein and the indirect shaping method is used instead. The intent of this is to avoid the above-explained problem.

Another option for avoiding this problem should lie in using galvannealed, coated steel since the iron content of 10% that is already present at the beginning and the absence of an Fe₂Al₅ barrier layer result in a more homogeneous formation of the coating from predominantly iron-rich phases. This results in a reduction or avoidance of zinc-rich, liquid phases.

The paper “STUDY OF CRACKS PROPAGATION INSIDE THE STEEL ON PRESS HARDENED STEEL ZINC BASED COATINGS” by Pascal Drillet, Raisa Grigorieva, Grégory Leuillier, and Thomas Vietoris, 8th International Conference on Zinc and Zinc Alloy Coated Steel Sheet, GALVATECH 2011—Conference Proceedings, Genoa (Italy), 2011” makes reference to the fact that galvanized sheets cannot be processed using the direct method.

EP 1 439 240 B1 has disclosed a method for hot forming a coated steel product; the steel material has a zinc or zinc alloy coating, which is formed on the surface of the steel material, and the steel base material with the coating is heated to a temperature of 700° C. to 1000° C. and hot formed; the coating has an oxide layer, which is mainly composed of zinc oxide, before the steel base material is heated with the zinc or zinc alloy layer in order to then prevent a vaporization of the zinc when it is heated. A special process sequence is provided for this.

EP 1 642 991 B1 has disclosed a method for hot forming a steel in which a component composed of a given boron/manganese steel is heated to a temperature at the Ac₃ point or higher, is kept at this temperature, and then the heated steel sheet is shaped into the finished component; the formed component is quenched by being cooled down from the forming temperature during or after the forming in such a way that the cooling rate at the M_{S} point at least corresponds to the critical cooling rate and the average cooling rate of the formed component from the M_{S} point to 200° C. lies in the range from 25° C./s to 150° C./s.

EP 1 651 789 B1, which belongs to the applicant, has disclosed a method for producing hardened components made of sheet steel; in this case, formed parts made of a steel sheet provided with a cathodic corrosion protection are cold-formed followed by a heat treatment for purposes of austenitization; before, during, or after the cold-forming of the formed part, a final trimming of the formed part and any needed punch-outs are performed or a hole pattern is produced and the cold forming, trimming, punching, and positioning of the hole pattern on the component should be 0.5% to 2% smaller than the dimensions of the component after final hardening; the cold-formed formed part that is heated for the heat treatment is then heated in at least some regions—accompanied by a supply of atmospheric oxygen—to a temperature that enables an austenitization of the steel material, and the heated component is then transferred to a die and in this die, a so-called form-hardening is carried out in which the contacting and pressing (holding) of the component by the form-hardening dies cools and thus hardens the component, and the cathodic corrosion protection coating is composed of a mixture essentially composed of zinc and also contains one or more elements with an oxygen affinity. As a result, an oxide skin, which is composed of the elements with the oxygen affinity, forms on the surface of the corrosion protection coating during the heating, which protects the cathodic corrosion protection layer, in particular the zinc layer. With the method, the reduction in scale of the component in terms of its final geometry also takes into account the thermal expansion of the component so that the form hardening requires neither a calibration nor a shaping.

WO 2010/109012 A1, which belongs to the applicant, has disclosed a method for producing partially hardened steel components; a sheet blank composed of a hardenable steel sheet is subjected to a temperature increase, which is sufficient for a quench hardening, and after a desired temperature and possibly a desired exposure time, the sheet blank is transferred to a forming die in which the sheet blank is formed into a component and at the same time, is quench hardened or else the sheet blank is cold formed and the component obtained from the cold forming is then subjected to a temperature increase; the temperature increase is carried out so that a temperature of the component is achieved that is necessary for a quench hardening and the component is then transferred to a die in which the heated component is cooled and thus quench hardened; during the heating of the sheet blank or component in order to increase the temperature to a temperature that is necessary for the hardening, absorption masses rest against the regions that are supposed to have lower hardness and/or higher ductility or these absorption masses are spaced apart from these regions by a small gap; in terms of their expansion and thickness, their thermal conductivity, and heat capacity, and/or with regard to their emissivity are dimensioned specifically so that the thermal energy being applied to the region of the component that is to remain ductile flows through the component and toward the absorption masses so that these regions remain cooler and in particular, do not reach or only partially reach the temperature that is required for the hardening so that these regions cannot be hardened or can only be partially hardened.

DE 10 2005 003 551 A1 has disclosed a method for hot forming and hardening a steel sheet in which a steel sheet is heated to a temperature above the Ac₃ point, then undergoes a cooling to a temperature in the range from 400° C. to 600° C., and is only formed after this temperature range is achieved. This cited reference, however, does not address the crack problem or a coating and it also does not describe a martensite formation. The object of the invention is to produce the intermediate structure, so-called bainite.

EP 2 290 133 A1 has disclosed a method for producing a steel component that is provided with a metallic, corrosion-protecting coating by means of forming a flat steel product, which is composed of Mn steel and which, prior to the forming of the steel component, is provided with a ZnNi alloy coating. With this method, the sheet blank is heated to a temperature of at least 800° C., having been previously coated with the ZnNi alloy coating. This cited reference does not address the problem of “liquid metal embrittlement.”

DE 10 2011 053 941 A1 has disclosed a similar method, but in this method, a sheet blank or a formed sheet blank is only heated to temperature >Ac₃ in some areas and is kept at this temperature for a predetermined time in order to carry out the austenite formation and then is transferred to a hardening die and hardened in this hardening die; the sheet blank is cooled at a speed that lies above the critical hardening speed. In addition, the material used therein is a delayed-transformation material; in the intermediate cooling step, the hotter austenitized regions and the less hot non-austenitized or only partially austenitized regions are adapted in terms of their temperature and the sheet blank or the formed sheet blank are homogenized with regard to their temperature.

DE 10 2011 053 939 A1 has disclosed a method for producing hardened components; in this case, a method for producing a hardened steel component is disclosed, which has a coating composed of zinc or a zinc alloy. A sheet blank is stamped out of this sheet and the stamped sheet blank is heated to a temperature ≥Ac₃ and as needed, is kept at this temperature for a predetermined time in order to carry out the austenite formation and is then transferred to a forming die, is formed therein, and in the forming die, is cooled at a speed that lies above the critical hardening speed and is thus hardened. In this case, the steel material used is adjusted in a transformation-delaying way so that at a forming temperature that lies in the range from 450° C. to 700° C., a quench hardening takes place through the transformation of the austenite into martensite; after the heating for austenitization purposes, but before the forming, an active cooling takes place so that the sheet blank is cooled from a starting temperature, which ensures the austenitization, to a temperature of between 450° C. and 700° C. so that despite the lower temperatures, a martensitic hardening takes place. This should achieve the fact that as little molten zinc as possible comes into contact with austenite during the forming phase, i.e. when stress is introduced, because the intermediate cooling that has been carried out causes the forming to take place at a temperature that lies below the peritectic temperature of the iron/zinc system. It should be noted that the cooling can be carried out with air nozzles, but is not limited to air nozzles, instead being equally usable on cooled tables or cooled presses.

The object of the invention is to further improve a method for the cooling and in particular, intermediate cooling, of a steel sheet for purposes of forming and hardening.

The object is attained with a method having the features of claim 1.

Advantageous modifications are disclosed in the dependent claims.

Another object of the invention is to create an apparatus for carrying out the method.

This object is attained by means of an apparatus having the features of claim 15.

Advantageous modifications are disclosed in the dependent claims that are dependent thereon.

According to the invention, at temperatures of 20° C. to 900° C., a cooling is ensured that permits a maximum temperature fluctuation of 30° C. within a square meter. The cooling mediums used are air gases and mixed gases, but can also be water or other fluids. Wherever only one of these fluids is mentioned hereinafter, it represents all of the above-mentioned fluids.

The invention should make it possible, for a low investment cost and with low operating costs, to achieve high system availability, high flexibility, and simple integration into existing production processes.

According to the invention, a surface to be cooled is moved by means of robots or linear drives in the X, Y, or Z plane, it being possible to preset any movement trajectories and speeds of the surface to be cooled. In this case, the oscillation is preferably around a rest position in the X and Y planes. It is optionally possible for there to be oscillation in the Z plane (i.e. in the vertical direction).

It is also easily possible for there to be cooling on one or both sides.

The cooling units according to the invention have nozzles, which are spaced apart from one another; the nozzles are spaced apart not only from one another, but are also spaced apart from a box, a support, or other surfaces.

The cooling units in this case are thus embodied so that the medium flowing away from the hot plate finds enough room and space between the nozzles and can be effectively conveyed away between the nozzles and as a result, no cross flow or transverse flows are produced.

The spaces between the nozzles in this case can be acted on with an additional cross flow in order to increase the cooling rate and thus to effectively convey away—i.e. to suck up, so to speak—the coolant that is flowing away from the hot plate. This cross flow, however, should not interfere with the coolant flowing from the nozzle to the plate, i.e. the free flow.

The cooling device in this case can have cooling blades, which extend away from a cooling box and have a row of nozzles at their free ends or free edges.

Furthermore, the cooling device can also be embodied in the form of individual cooling columns that protrude from a support surface; these cooling columns support at least one nozzle on their face or tip facing away from the support surface. The cooling columns in this case can have a cylindrical cross-section or some other cross-section; the cross-section of the cooling columns can also be adapted to desired cross flows and can be embodied as oval, resembling a flat bearing surface, polygonal, or the like.

Naturally, mixed forms are also possible, in which the cooling blades are embodied not as continuous, but rather as discontinuous or, when cooling columns are embodied in the form of broad ovals, a plurality of nozzles protrude from a column tip.

The geometry of the nozzle openings or outlet openings of the nozzles runs the gamut from simple, round geometries to complex, geometrically defined embodiments.

Preferably, the nozzles or rows of nozzles are offset from one another so that the cooling columns or blades can be offset from one another in such a way that the nozzles form an offset pattern or other pattern. Especially with cooling on both sides, this also applies to the positioning of the nozzles or rows of nozzles of the top relative to those on the underside.

The nozzles are preferably embodied in such a way that it is possible to restrict and if necessary, even shut off the flow passing through the nozzle. For example, individual, triggerable pins can be provided for each nozzle, which are able to restrict the passage of gas. A different cooling action, for example, can also be achieved in that the distance from the nozzle outlet opening to the surface to be cooled is set differently, e.g. by means of different cooling column heights. The advantage of this method lies in the continuous flow through each nozzle and thus in easily predictable flow conditions since the flow resistances remain virtually unchanged by the height changes.

According to the invention, the preferred flow pattern on the surface to be cooled should have a honeycomb-like structure.

If the cooling takes place by means of at least one cooling blade, then the cooling blade is a plate-like element, which can also taper from a base toward an outlet strip; and at least one nozzle is mounted in the outlet strip. In this case, the blade is embodied as hollow so that the nozzle can be supplied with a cooling fluid from the hollow blade. The nozzles can be spaced apart from one another with wedge-like elements; the wedge-like elements can also narrow the space for the flowing fluid in the direction toward the nozzle.

In particular, this produces a twisting of the emerging jet of fluid.

Preferably, a plurality of blades is provided, situated next to one another, with the blades being offset from one another.

The offset arrangement likewise produces a cooling with points that are offset from one another, with the points blending into one another to produce homogeneous cooling and the emerging fluid is sucked up in the region between two blades and conveyed away.

Preferably the following conditions are present:
hydraulic diameter of nozzle=DH, where DH=4×A/U
distance of nozzle from body=H
distance between two cooling blades/cooling columns=S
length of nozzle=L

L>=6×DH

H<=6×DH, esp. 4 to 6×DH

S<=6×DH, esp. 4 to 6×DH(staggered array)
oscillation=half of the spacing distance between two cooling blades in X, Y (poss. Z)

If the cooling is carried out with cooling columns, then these are arranged in corresponding fashion.

In this case, the element to be cooled, e.g. a plate to be cooled, is preferably moved so that the movement of the plate one the one hand and the offset arrangement of the nozzles on the other ensures that the cooling fluid flows across all of the regions of the plate so that a homogeneous cooling is achieved.

The invention will be explained by way of example based on the drawings. In the drawings:

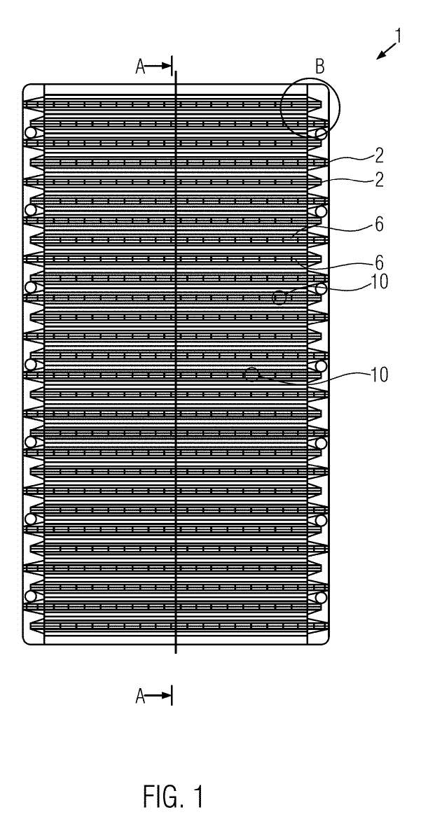

FIG. 1 shows a top view of a plurality of nozzle blades arranged parallel to one another;

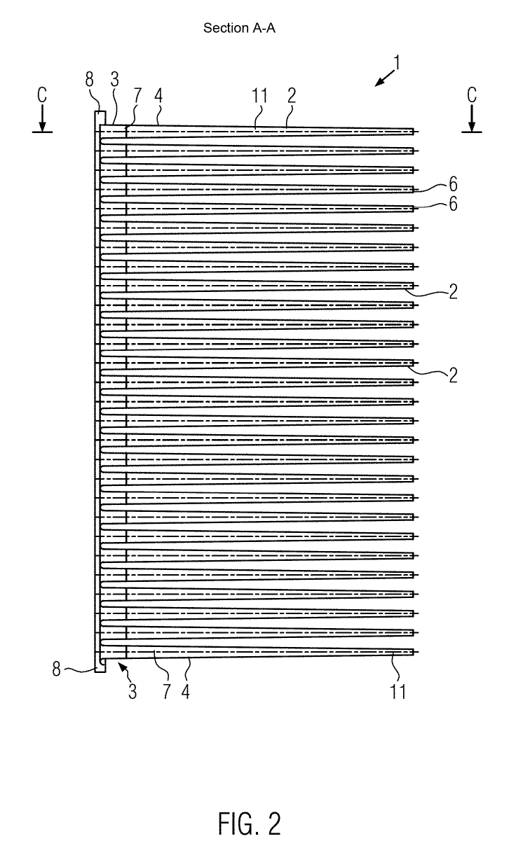

FIG. 2 shows the arrangement of nozzle blades according to the section A-A in FIG. 1;

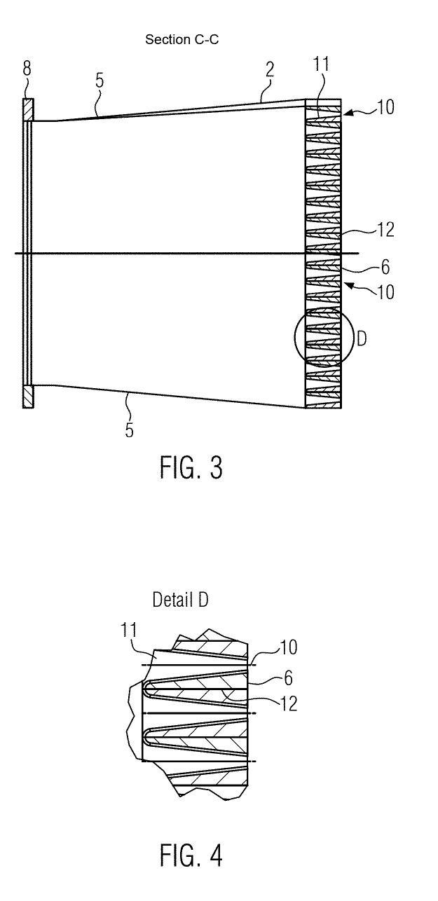

FIG. 3 shows a longitudinal section through a nozzle blade according to the section line C-C in FIG. 2;

FIG. 4 is an enlargement of the detail D from FIG. 3, showing the nozzles;

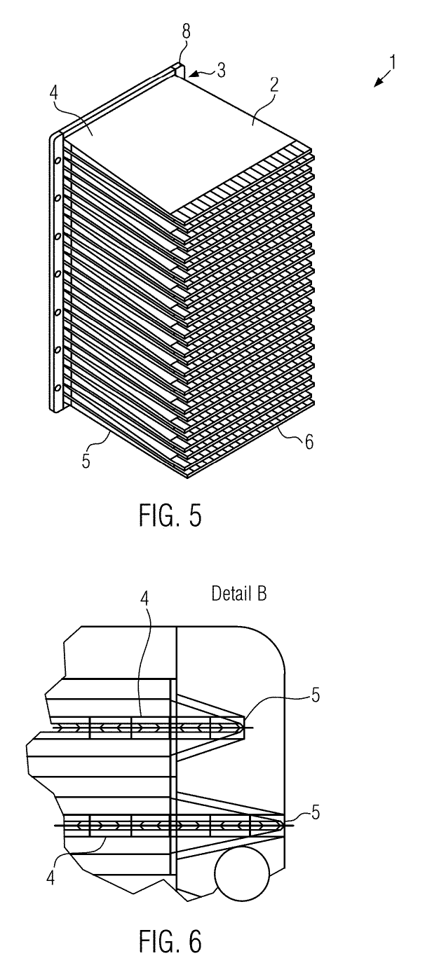

FIG. 5 is a schematic, perspective view of the arrangement of nozzle blades;

FIG. 6 is an enlarged detail of the edge region of the nozzle blades, with an offset within the arrangement of blades;

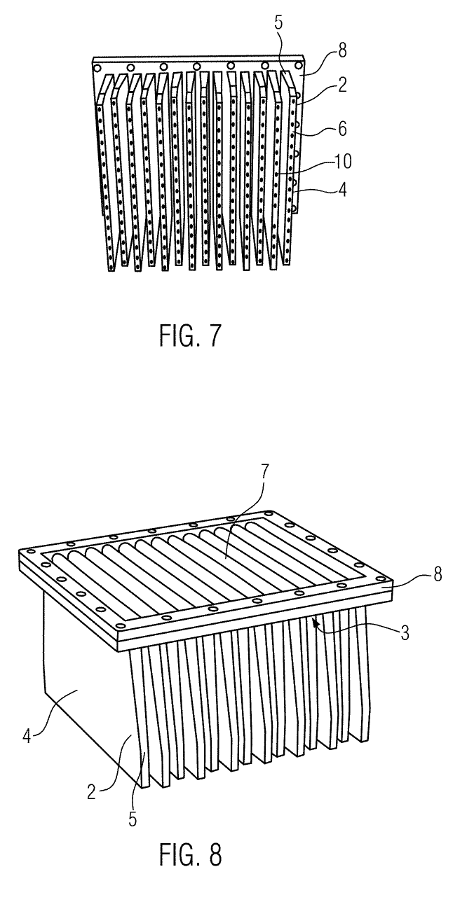

FIG. 7 is a perspective view of an arrangement of cooling blades according to the invention, which are consolidated into a cooling block;

FIG. 8 is a perspective rear view of the arrangement according to FIG. 7;

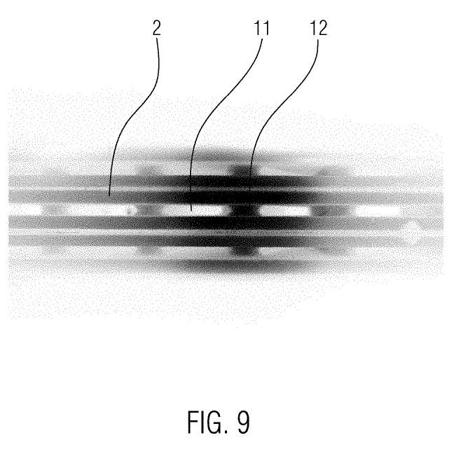

FIG. 9 is a view into the interior of cooling blades according to the invention;

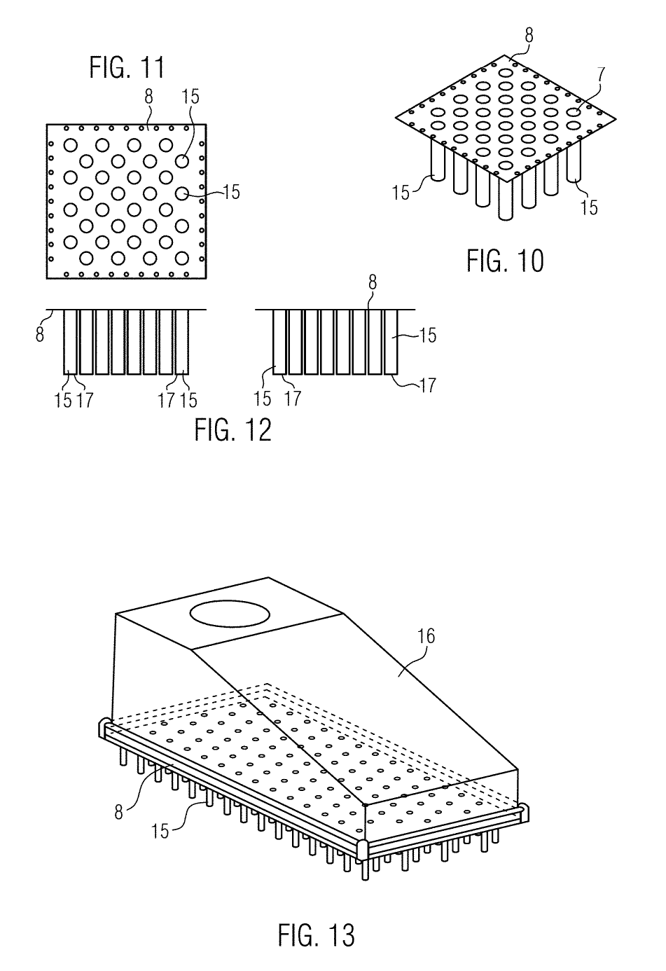

FIG. 10 is a very schematic perspective view of an arrangement of nozzle columns in a frame;

FIG. 11 shows a top view of the embodiment according to FIG. 10;

FIG. 12 shows a side view of the arrangement according to FIGS. 10 and 11;

FIG. 13 shows the embodiment according to FIGS. 10 through 12 with a cooling box;

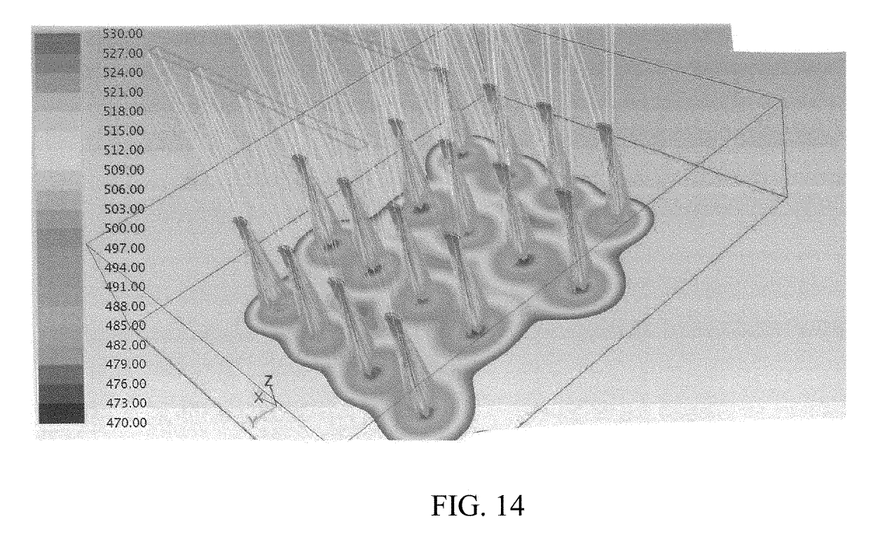

FIG. 14 depicts the cooling blades with the nozzles, showing a plate to be cooled, the temperature distribution, and the fluid temperature distribution;

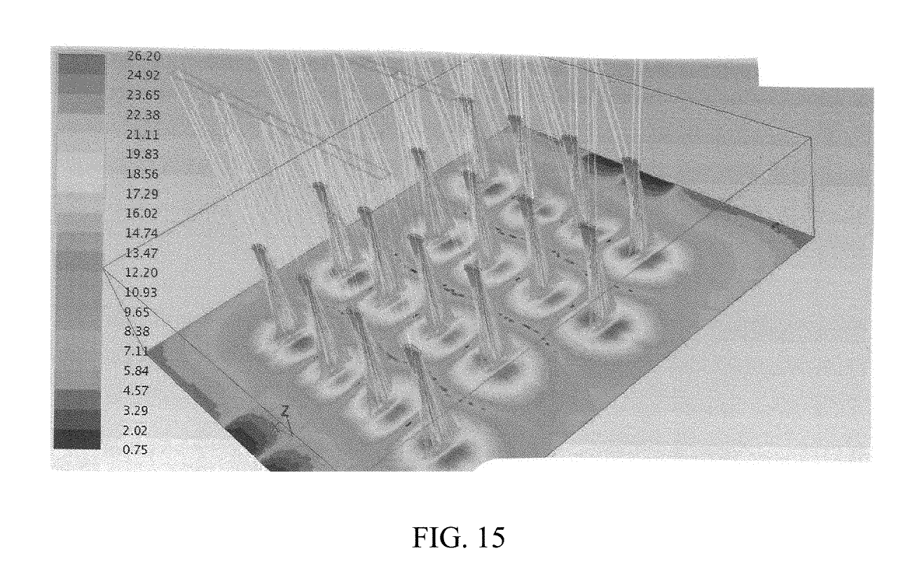

FIG. 15 is a view of the arrangement according to FIG. 10, showing the speed distribution;

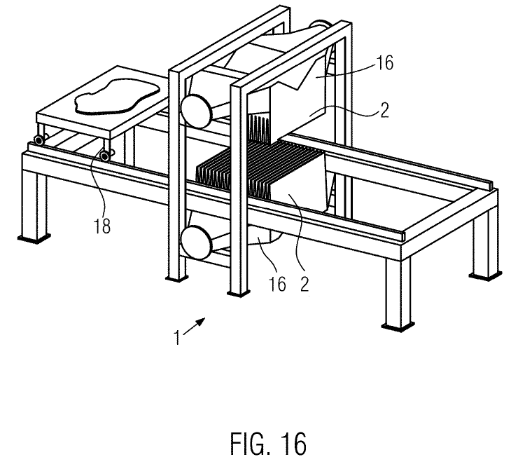

FIG. 16 schematically depicts the arrangement of two opposing cooling boxes composed of a plurality of cooling blades according to the invention arranged offset from one another and a moving carriage for taking an article to be cooled and conveying it through;

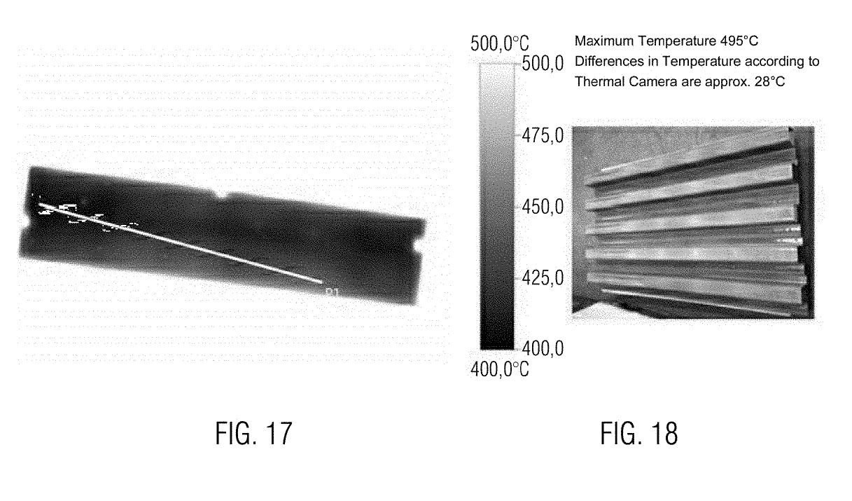

FIG. 17 shows the temperature distribution on a plate that has been cooled with an apparatus according to the invention;

FIG. 18 shows a structured, cooled component;

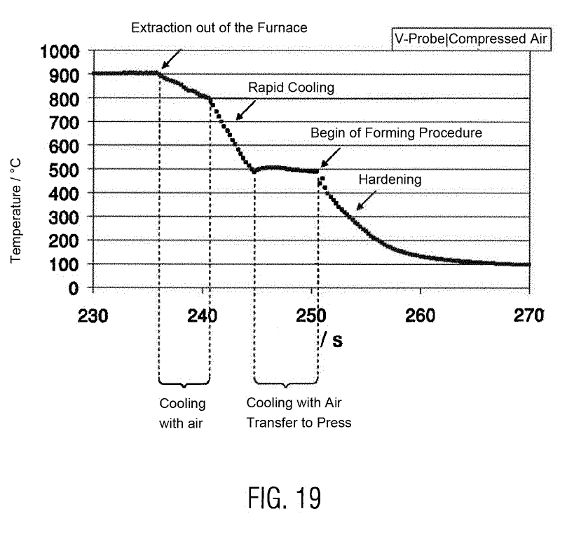

FIG. 19 shows the time/temperature curve of the cooling between the furnace and the forming procedure;

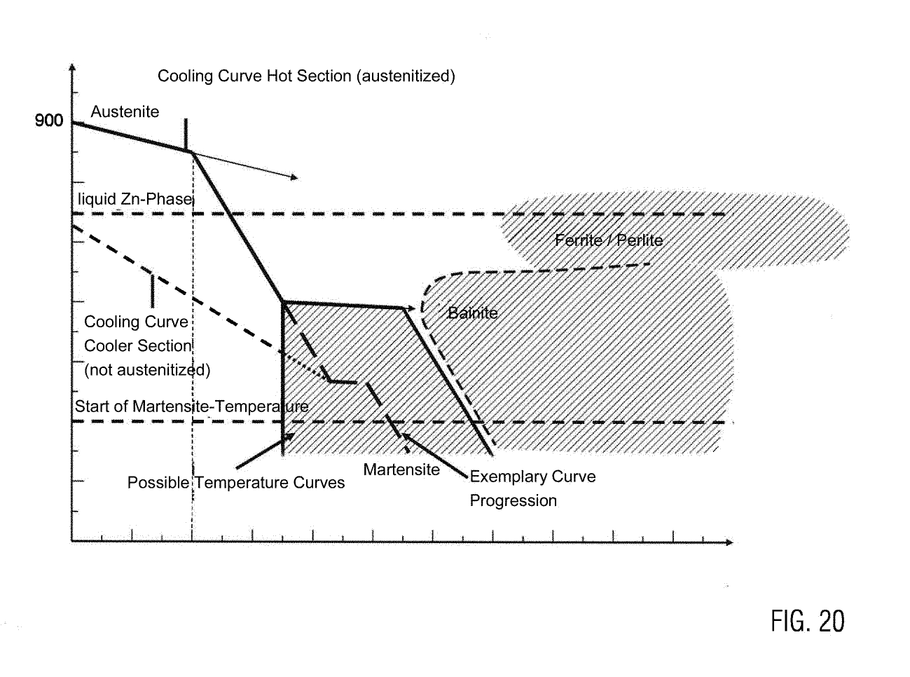

FIG. 20 shows the zinc/iron diagram, with corresponding cooling curves for sheet metals with differently heated regions.

One possible embodiment will be described below.

The cooling apparatus 1 according to the invention has cooling devices 2, 15, which have nozzles 10 that are spaced apart from one another; the nozzles 10 are spaced apart not only from one another, but also from a box 16, a carrier, or other surfaces supporting the cooling devices 2, 15.

The cooling devices 2, 15 in this case are correspondingly embodied so that the medium flowing from the hot plate finds enough room and space between the nozzles 10 and can plunge between the nozzles so to speak and thus no cross flow or transverse flow is produced on the surface to be cooled.

In this case, the spaces between the nozzles 10 can be acted on with an additional cross flow in order to increase the flow rate and thus to suck up, so to speak, the cooling medium flowing away. This cross flow, however, should not impede the incoming cooling medium from the nozzle to the plate, i.e. the free flow.

The cooling apparatus 1 in this case can have a cooling device 2 in the form of at least one cooling blade 2, which extends away from a cooling box 16 and has a row of nozzles 10 at its free ends or its free edge 6.

The cooling device can also have individual cooling columns 15 protruding up from a surface; these cooling columns 15 each support at least one nozzle 10 on their face or tip 17 facing away from the surface. The cooling columns 15 in this case can have a cylindrical or other cross-section; the cross-section of the cooling columns 15 can also be adapted to desired cross flows and can be embodied as oval, resembling a flat bearing surface, or the like.

Naturally, mixed forms are also possible, in which the cooling blades 2 are embodied not as continuous, but rather as discontinuous or, when cooling columns 15 are embodied in the form of broad ovals, a plurality of nozzles 10 protrude from a column tip. Another conceivable alternative would be for a plurality of cooling columns to be connected by means of baffles, making it possible to influence the cross flow.

The geometry of the nozzle openings or outlet openings of the nozzles runs the gamut from simple, round geometries to complex, geometrically defined embodiments.

Preferably, the nozzles 10 or nozzle rows are positioned offset from one another so that the cooling columns 15 or blades 2 are also positioned offset from one another in such a way that the nozzles 10 form an offset pattern or some other pattern.

An example of a cooling apparatus 1 according to the invention has at least one cooling blade 2. The cooling blade 2 is embodied in the form of an elongated flap and has a cooling blade base 3, two cooling blade broad sides 4 extending away from the cooling blade base, two cooling blade narrow sides 5 that connect the cooling blade broad sides, and a free nozzle edge 6.

The cooling blade 2 is embodied as hollow with a cooling blade cavity 7; the cavity is enclosed by the cooling blade broad sides 4, the cooling blade narrow sides 5, and the nozzle edge 6; the cooling blade is open at the base 3. With the cooling blade base 3, the cooling blade is inserted into a frame 8; and the frame 8 can be placed onto a hollow fluid supply box 16.

The region of the nozzle edge 6 is provided with a plurality of nozzles 10 or openings, which reach into the cavity 7 and thus permit fluid to flow out of the cavity to the outside through the nozzles 10.

From the nozzles 10, nozzle conduits 11 extend into the cavity 7, spatially separating the nozzles 10 from one another, at least in the region of the nozzle edge 6. The nozzle conduits 11 in this case are preferably embodied as wedge-shaped so that the nozzle conduits or nozzles are separated from one another by wedge-shaped struts 12. Preferably, the nozzle conduits are embodied so they widen out in the direction toward the cavity 7 so that an incoming fluid is accelerated by the narrowing of the nozzle conduits.

The cooling blade broad sides 4 can be embodied as converging from the cooling blade base 3 toward the nozzle edge 6 so that the cavity 7 narrows in the direction toward the nozzle edge 6.

In addition, the cooling blade narrow sides 5 can be embodied as converging or diverging.

Preferably, at least two cooling blades 2 are provided, which are arranged parallel to each other in relation to the broad sides; with regard to the spacing of the nozzles 10, the cooling blades 2 are offset from one another by a half nozzle distance.

It is also possible for there to be more than two cooling blades 2.

With regard to the span of the nozzle edge 6, the nozzles 10 can likewise be embodied as longitudinally flush with the nozzle edge 6; the nozzles 10, however, can also be embodied as round, oval and aligned with the nozzle edge 6 or oval and transverse to the nozzle edge, hexagonal, octagonal, or polygonal.

Particularly if the nozzles 10, with regard to the longitudinal span of the nozzle edge, are likewise embodied as oblong, particularly in the form of an oblong oval or oblong polygon, this causes a twisting of an emerging jet of fluid (FIGS. 10 & 11); an offset arrangement by half a nozzle spacing distance yields a cooling pattern on a plate-like body (FIG. 10), which is correspondingly offset.

In another advantageous embodiment (FIGS. 10 through 13), the frame 8 is provided with a plurality of protruding cooling columns 15 or cylinders 15, which each have at least one nozzle 10 at their free outer tip 17 or face 17. This frame 8 is likewise inserted into a cooling box 16 (FIG. 13) so that fluid flowing into the cooling box 16 comes out of the respective cooling columns 15 and nozzles 10. By contrast with the cooling blades 2, in this embodiment, the nozzles 10 are isolated so to speak; statements above about the nozzles 10 and their geometry and about the nozzle conduits 11 apply to this embodiment as well.

In the nozzle conduits 11, devices can be provided, which, by sliding axially, can reduce the effective nozzle cross-section and thus influence the gas flow. For example, such devices can be suitably embodied in the form of pins, which have a cross-section that corresponds to the cross-section of the nozzle in the outlet region; the pins can be adapted to a shape of the nozzle conduit 11, for example having a conical shape. The pins can be embodied in individually sliding fashion so that when they are slid into the nozzle conduit, they reduce the effective nozzle cross-section or nozzle conduit cross-section and thus influence the gas flow and the flow speed.

When a pin is slid all the way in, the nozzle 10 is preferably completely closed.

The pins of the nozzles 10 can be triggered individually, row by row, blade by blade, or grouped in some other way, making it possible to produce a certain flow profile in the cooling device so that an article to be cooled is not cooled uniformly, but rather with different intensities.

Alternatively to pins, it is also possible to use freely embodied apertures or diaphragms, which ensure the desired flow profile to the article to be cooled.

In order to influence the cooling rate, it would also be conceivable to partially modify the length and/or height of the cooling blades or cooling columns.

This influencing of the cooling is advantageous for many intended uses, first of all in order to provide different levels of cooling of flat sheet blanks so as to produce regions with different mechanical properties, but also for tailor-welded blanks (TWB), tailor-rolled blanks (TRB), or tailor-heated blanks (THB) in order to cool the different-thickness sheet sections and/or the differently tempered sheet regions with a respectively adapted cooling rate so as to obtain a homogeneously tempered article.

The corresponding speed profile also produces a corresponding distribution (FIG. 15).

According to the invention, it has turned out that fluid flowing out of the nozzles 10 does in fact strike the surface of a body to be cooled (FIGS. 10 & 11), but it clearly flows away, plunging between the at least two blades 2 or cooling columns 15 of the cooling apparatus 1 so that the cooling flow at the surface of a body to be cooled is not interrupted.

For example, a cooling apparatus 1 (FIG. 12) has two arrangements of cooling blades 2 or two rows of cooling columns 15 in a frame 8; the frames 8 are embodied with corresponding fluid supplies 14 and particularly on the side oriented away from the cooling blades 2 or cooling columns 15, are provided with a fluid box 16 that contains pressurized fluid, in particular by means of a supply of pressurized fluid.

In addition, a moving device 18 is provided; the moving device 18 is embodied so that a body to be cooled can be conveyed through between the opposing cooling blade arrangements in such a way that a cooling action can be exerted on both sides of the body to be cooled. For a moving device of a serial press-hardening system, for example the transfer device between the furnace and press can be operated, for example, by means of robots or linear drives. In a preferred embodiment in this case, the body to be cooled does not have to be set down by the moving device and it does not have to be re-grasped, i.e. the cooling takes place when the body to be cooled is in the grasped state, on the way from the furnace to the press.

The distances of the nozzle edges 6 from the body to be cooled in this case are, for example, 5 mm to 250 mm.

Through a relative movement either of the cooling apparatus 1 in relation to a body to be cooled or vice versa, the cooling pattern according to FIG. 10 moves across the surface of the body to be cooled; the medium flowing away from the hot body finds enough room between the cooling blades 2 or cooling columns 15 and thus no cross flow is produced on the surface to be cooled.

According to the invention, the spaces between are acted on with corresponding flow mediums by means of an additional cross flow in order for the medium flowing against the hot body to be sucked up between the blades.

According to the invention, a conventional boron/manganese steel such as a 22MnB5 or 20MnB8 for use as a press-hardening steel material is used with regard to the transformation of austenite into other phases; in this material, the transformation is shifted into lower ranges and martensite can be formed.

Steels of the following alloy composition are thus suitable for the invention (all indications in % by mass):

| | | | P | S | Al | Cr | | B | N |
|---|---|---|---|---|---|---|---|---|---|
| C [%] | Si [%] | Mn [%] | [%] | [%] | [%] | [%] | Ti [%] | [%] | [%] |
| 0.20 | 0.18 | 2.01 | 0.0062 | 0.001 | 0.054 | 0.03 | 0.032 | 0.0030 | 0.0041 |

residual iron and melting-related impurities;
in particular, the alloying elements boron, manganese, carbon, and optionally chromium and molybdenum are used as transformation-delaying agents in such steels.

Steels of the following general alloy composition are also suitable for the invention (all indications in % by mass):

| | |
|---|---|
| carbon (C) | 0.08-0.6 |
| manganese (Mn) | 0.8-3.0 |
| aluminum (Al) | 0.01-0.07 |
| silicon (Si) | 0.01-0.5 |
| chromium (Cr) | 0.02-0.6 |
| titanium (Ti) | 0.01-0.08 |
| nitrogen (N) | <0.02 |
| boron (B) | 0.002-0.02 |
| phosphorus (P) | <0.01 |
| sulfur (S) | <0.01 |
| molybdenum (Mo) | <1 |

residual iron and melting-related impurities.

The following steel compositions have turned out to be particularly suitable (all indications in % by mass):

| | |
|---|---|
| carbon (C) | 0.08-0.30 |
| manganese (Mn) | 1.00-3.00 |
| aluminum (Al) | 0.03-0.06 |
| silicon (Si) | 0.01-0.20 |
| chromium (Cr) | 0.02-0.3 |
| titanium (Ti) | 0.03-0.04 |
| nitrogen (N) | <0.007 |
| boron (B) | 0.002-0.006 |
| phosphorus (P) | <0.01 |
| sulfur (S) | <0.01 |
| molybdenum (Mo) | <1 |

residual iron and melting-related impurities.

Adjusting the alloying elements that function as transformation-delaying agents reliably achieves a quench hardening, i.e. a rapid cooling with a cooling speed that lies above the critical hardening speed, even at temperatures below 780° C. This means that in this case, processing is carried out below the peritectic of the zinc/iron system, i.e. mechanical stress is only exerted below the peritectic. This also means that at the moment in which mechanical stress is exerted, there are no longer any zinc phases that can come into contact with the austenite. Another advantage of setting a greater transformation delay is the longer transfer time that this enables between the cooling device and the forming press, which, because of thermal conduction within the body to be cooled, can be used to achieve an additional homogenization of the temperature.

FIG. 19 shows an advantageous temperature progression for an austenitized steel sheet; it is clear that after the heating to a temperature above the austenitization temperature and the corresponding placement in a cooling device, a certain amount of cooling has already taken place. This is followed by a rapid intermediate cooling step. The intermediate cooling step is advantageously performed at cooling speeds of at least 15 K/s, preferably at least 30 K/s, and more preferably at least 50 K/s. Then the sheet blank is transferred to the press and the forming and hardening are carried out.

The iron/carbon diagram in FIG. 20 shows how, for example, a sheet blank with different hot regions is correspondingly treated. In this case, the diagram shows a high starting temperature of between 800° C. and 900° C. for the hot regions that are to be hardened, whereas the soft areas have been heated to a temperature below 700° C. and in particular, cannot then undergo a hardening. A temperature equalization is visible at a temperature of approximately 550° C. or slightly lower; after an intensified cooling of the hotter regions, the temperature of the soft regions experiences a rapid cooling at about 20 K/s.

For purposes of the invention, it is sufficient in this regard if the temperature equalization is carried out in such a way that there are still differences in the temperatures of the (formerly) hot regions and the (formerly) cooler regions that do not exceed 75° C., in particular 50° C. (in both directions).

With a homogeneously heated sheet blank, the intermediate cooling is preferably carried out by placing the sheet blank into the cooling apparatus and directing a homogeneous flow of a gaseous cooling medium at it by means of the nozzles of the cooling blades, thus cooling it to a uniform, lower temperature.

For the case in which a sheet blank is heated to the austenitization temperature in only some areas, the nozzles and/or cooling blades are triggered in such a way and in particular, the nozzles are triggered by means of the devices or pins in such a way that only the hot regions are cooled to at least the peritectic temperature of the zinc/iron diagram and the remaining regions are subjected to less flow or none at all in order to achieve a homogenization of the temperature in the sheet blank. This ensures that a sheet blank, which is homogeneous in terms of its temperature, is inserted into the forming and quenching device.

It is also possible to process sheet blanks, which are composed of different sheets, i.e. sheets with different qualities of steel or sheets of different thicknesses. For example, a composite sheet blank that is composed of different sheets of different thicknesses will also have to be cooled differently since a thicker sheet has to be cooled more intensely than a correspondingly thinner sheet at the same temperature. The apparatus is therefore also able to carry out a rapid, homogeneous intermediate cooling of a sheet blank with different sheet thicknesses, regardless of whether it is composed of sheet elements of different thicknesses that have been assembled or welded together or is composed of different rolling thicknesses.

With the invention, it is advantageously possible to achieve a homogeneous cooling of hot elements that is inexpensive and has a high degree of variability with regard to the target temperature and possible throughput times.

The invention also offers the advantage that in a very reliable way, a steel sheet blank can be subjected to a very exact, highly reliable, very rapid intermediate cooling across its entire area or in some areas before being inserted into a forming die or a form-hardening die.

### REFERENCE NUMERALS

1 cooling apparatus
2 cooling blade
3 cooling blade base
4 cooling blade broad sides
5 cooling blade narrow sides
6 nozzle edge
7 cavity
8 frame
10 nozzles
11 nozzle conduits
12 wedge-shaped struts
14 fluid supplies
15 columns
16 box
17 column edge/tip
18 movement direction

1. A method for producing a hardened steel component in which a sheet blank is stamped out and the stamped sheet blank is heated to a temperature ≥Ac₃ and as needed, is kept at this temperature for a predetermined time in order to carry out the austenite formation and then the sheet blank, which has been heated all over or only in some regions, is transferred to a forming die, is formed in the forming die, and in the forming die, is cooled at a speed that lies above the critical hardening speed and is thus hardened or else is completely cold formed and the formed sheet blank is heated all over or only in some regions to a temperature >Ac₃ and as needed, is kept at this temperature for a predetermined time in order to carry out the austenite formation and then the sheet blank, which has been heated and faulted all over or only in some regions, is transferred to a hardening die, and is hardened in the hardening die at a speed that lies above the critical hardening speed; the steel material is adjusted in a transformation-delaying way so that at a forming temperature that lies in the range from 450° C. to 700° C., a quench hardening takes place through the transformation of the austenite into martensite; after the heating and before the forming, an active cooling takes place in which the sheet blank or parts of the sheet blank is/are cooled at a cooling speed of >15 K/s,
characterized in that
for the homogeneous, contactless cooling of hot sheet blanks or components, a cooling apparatus (1) and an article with a hot surface are moved relative to each other; the cooling apparatus (1) has at least two cooling blades (2) or cooling columns (15) that are parallel to and spaced apart from each other; oriented toward the sheet blank to be cooled or the component to be cooled, the cooling blades (2) or cooling columns (15) have a nozzle edge (6, 17) with nozzles (10); the nozzles (10) direct a cooling fluid at the surface of the sheet blank to be cooled or the article to be cooled and after the cooling fluid contacts the hot surface, it flows away in the space between the blades (2) or cooling columns (15).

2. The method according to claim 1, characterized in that the steel material contains boron, manganese, carbon, and optionally chromium and molybdenum as transformation-delaying agents.

3. The method according to claim 1, characterized in that a steel material with the following composition analysis is used (all indications in % by mass):

| | |
|---|---|
| carbon (C) | 0.08-0.6 |
| manganese (Mn) | 0.8-3.0 |
| aluminum (Al) | 0.01-0.07 |
| silicon (Si) | 0.01-0.5 |
| chromium (Cr) | 0.02-0.6 |
| titanium (Ti) | 0.01-0.08 |
| nitrogen (N) | <0.02 |
| boron (B) | 0.002-0.02 |
| phosphorus (P) | <0.01 |
| sulfur (S) | <0.01 |
| molybdenum (Mo) | <1 |

residual iron and melting-related impurities.

4. The method according to claim 1, characterized in that a steel material with the following composition analysis is used (all indications in % by mass):

| | |
|---|---|
| carbon (C) | 0.08-0.30 |
| manganese (Mn) | 1.00-3.00 |
| aluminum (Al) | 0.03-0.06 |
| silicon (Si) | 0.01-0.20 |
| chromium (Cr) | 0.02-0.3 |
| titanium (Ti) | 0.03-0.04 |
| nitrogen (N) | 0.007 |
| boron (B) | 0.002-0.006 |
| phosphorus (P) | <0.01 |
| sulfur (S) | <0.01 |
| molybdenum (Mo) | <1 |

residual iron and melting-related impurities.

5. The method according to claim 1, characterized in that the sheet blank is heated in a furnace to a temperature >Ac₃ and is kept at this temperature for a predetermined time and then the sheet blank is cooled to a temperature of between 500° C. and 600° C. in order to solidify the zinc layer and the sheet blank is then transferred to the forming die and formed therein.

6. The method according to claim 1, characterized in that the active cooling is carried out so that the cooling rate is >30 K/s.

7. The method according to claim 6, characterized in that the active cooling is carried out so that the cooling takes place at a rate of more than 50 K/s.

8. The method according to claim 1, characterized in that in sheet blanks, which in order to produce different hardness regions, have corresponding regions that are subject to different intensities of heating, the active cooling is carried out so that after the active cooling, the formerly hotter, austenitized regions are equalized to the less intensively heated regions in terms of their temperature level (+/−50 K) so that the sheet blank is inserted into the forming die with an essentially uniform temperature.

9. The method according to claim 1, characterized in that the active cooling is produced by blowing with air, gas, or other fluids.

10. The method according to claim 1, characterized in that the cooling progress and/or the temperature upon insertion into the forming die is/are monitored by means of sensors, in particular pyrometers, and the cooling is appropriately controlled.

11. The method according to claim 1, characterized in that a steel material that is coated with zinc or a zinc alloy is used as the steel material.

12. The method according to claim 1, characterized in that the cooling blade (2) and/or the cooling columns (15) and/or the cooling apparatus has/have devices (18) with which the apparatus is able to move around the X, Y, or Z axis, particularly in a swinging or oscillating fashion.

13. The method according to claim 1, characterized in that the following conditions are present:
hydraulic diameter of nozzle=DH, where DH=4×A/U
distance of nozzle from body=H
distance between two cooling blades/cooling columns=S
length of nozzle=L
L>=6×DH
H<=6×DH, esp. 4 to 6×DH
S<=6×DH, esp. 4 to 6×DH(staggered array)
oscillation=half of the spacing distance between two cooling blades in X, Y (poss. Z)

14. The method according to claim 1, characterized in that the devices (18) for moving the apparatus produce an oscillation speed of 0.25 seconds per cycle.

15. An apparatus for cooling hot steel sheet blanks or sheet steel components, particularly for carrying out a method according to claim 1, in which the cooling apparatus has at least one cooling blade (2) or a number of cooling columns (15); the cooling blade (2) or cooling column (15) is embodied as hollow and has a nozzle edge (6, 17); in the nozzle edge (6, 17) there is at least one nozzle (10), which is aimed at an article to be cooled; a plurality of cooling blades (2) or a plurality of rows of cooling columns (15) are arranged in such a way that the flow pattern on the surface to be cooled forms a honeycomb-like structure, characterized in that a moving device (18) is provided, which is able to move the cooling blade(s) (2) or cooling columns (15) together with the frame (8) and the fluid supply box (16) across a body to be cooled or which is able to move the body to be cooled relative to the cooling blades (2) or cooling columns (15); the cooling blade (2) and/or the cooling columns (15) and/or the cooling apparatus has/have devices (18) that are able to move the apparatus around the X, Y, or Z axis in a swinging or oscillating fashion.

16. The apparatus according to claim 15, characterized in that a plurality of cooling blades (2) or cooling columns (15) is provided, which are positioned parallel to and spaced apart from one another.

17. The apparatus according to claim 15, characterized in that the cooling blades (2) or cooling columns (15) are respectively offset from one another by half the distance between the nozzles (10) at the nozzle edge (6).

18. The apparatus according to claim 15, characterized in that the cooling blade(s) (2) has/have a cooling blade base (3), cooling blade broad sides (4), cooling blade narrow sides (5), and a nozzle edge (6); the nozzle edge (6), the cooling blade broad sides (4), and the cooling blade narrow sides (5) border a cavity (7), and the cooling blade(s) (2) is/are placed with the cooling blade base (3) in or on a frame (8); and the frame (8) can be placed onto a fluid box (15) for purposes of the fluid supply.

19. The apparatus according to claim 15, characterized in that the following conditions are present:
hydraulic diameter of nozzle=DH, where DH=4×A/U
distance of nozzle from body=H
distance between two cooling blades/cooling cylinders=S
length of nozzle=L
L>=6×DH
H<=6×DH, esp. 4 to 6×DH
S<=6×DH, esp. 4 to 6×DH(staggered array)
oscillation=half of the spacing distance between two cooling blades in X, Y (poss. Z).

20. The apparatus according to claim 15, characterized in that the devices (18) for moving the apparatus produce an oscillation speed of 0.25 seconds per cycle.

21-22. (canceled)
